(19) United States
(12) Patent Application Publication
(10) Pub. No.: US 2020/0130407 A1
(43) Pub. Date: Apr. 30, 2020

(54) HYBRID RIM OF A WHEEL WITH A WHEEL HUB MOTOR

(71) Applicant: CITIC DICASTAL CO., LTD., Qinhuangdao, Hebei (CN)

(72) Inventors: Thomas BUSCHJOHANN, Nordstemmen (DE); Stefan GEISLER, Sarstedt (DE)

(21) Appl. No.: 16/085,994

(22) PCT Filed: Mar. 7, 2017
(86) PCT No.: PCT/DE2017/100178

§ 371 Date: Sep. 17, 2018

(30) Foreign Application Priority Data
Mar. 18, 2016 (DE) 10 2016 105 050.4

(51) Int. Cl. B60B 3/04; B60K 7/00; B60B 5/02; B60B 3/10; B60B 3/14

(52) U.S. Cl. CPC B60B 3/041; B60K 7/0007; B60B 5/02; B60B 3/10; B60B 3/14; B60B 2310/30; B60B 2360/104; B60B 2360/3412; B60B 2360/3416; B60B 2310/202; B60B 2310/208; B60B 2900/513

(57) ABSTRACT

A hybrid rim of a wheel provided with a wheel hub motor of a motor vehicle includes a non-metal part and a metal part, wherein a rotor housing of the wheel hub motor at least partially forms the metal part of the hybrid rim.

### TECHNICAL FIELD

The disclosure relates to a hybrid rim of a wheel provided with a wheel hub motor.

### BACKGROUND

It is known to install an electric motor as wheel hub motor in the interior room of a rim. The wheel hub motor has an electric motor with a rotor and a stator, in which the rotor interacts with the stator to produce a motor torque, and in which the rotor is arranged to be rotatable about a main axis of rotation relative to the stator. The stator is arranged rotationally-secured to the vehicle. In contract, the rotor is connected with a wheel in a rotationally-secured manner. As known, the rotor and the wheel overlap in radial direction to the main axis of rotation. The wheel is in particular directly connected to the rotor.

Wheel hub motors are used in various embodiments in electric motor vehicles, in which the drive torque is not transmitted via a gear to a driven wheel, but the driven wheel is directly connected to a rotor of the wheel hub motor. For example, DE 10 2006 040 220 A1, DE 10 2008 019 974 B4 or DE 10 2013 202 592 A1 disclose wheel hub motors for motor vehicles.

A known wheel hub motor is an outer rotor-type electric motor, in which a rotor is arranged on an outer side of a stator. The rotor includes a rotor housing with an annular structure and permanent magnets, which are mounted on the inner circumference of the rotor housing. The rotor housing is arranged in the interior room of the rim, in which the rotor is configured as external rotor.

### SUMMARY

Based on this prior art, the object of the present disclosure is to improve a rim for motor vehicles operated with wheel hub motors.

According to the disclosure, this object is achieved by a hybrid rim with the features of claim 1. Preferred or advantageous embodiments of the disclosure will be acquired from the dependent claims, the following description and the accompanying figures.

The hybrid rim of a wheel provided with a wheel hub motor according to the disclosure, in particular of a motor vehicle, includes a non-metal part and a metal part, in which the rotor housing of the wheel hub motor at least partially forms the metal part of the hybrid rim.

The wheel hub motor provided for this type hybrid rim is thus an electric motor of the aforementioned outer rotor-type.

By this measure, on the one hand compared to a conventional rim, which accommodates a rotor housing as such in the interior room, new free space or structural space are created, for example, for useful components of the wheel hub motor, in which due to the addition of free space or structural space, wheel hub motors with a higher power can be provided ready for use. In this regard, at least a part of the rotor housing takes over quasi at least partially the function of the rim.

On the other hand, by the combination of non-metal part and metal part, weight can be saved favorably.

Since a wheel change in this type of rim configuration according to the disclosure is not readily feasible, it may be advantageous when the rim is configured such that a tire with emergency running properties, so-called RunFlat tires, can be pulled onto the rim according to the disclosure.

It may be advantageous when the non-metal part and the metal part are connected to each other in a form-, force- and/or material-fitting manner, in order to form the hybrid rim.

Non-metal part and metal part can first be completed separately, and subsequently connected together with each other. Another possibility is to first produce the metal part and then connect this with the non-metal part in the producing process or during the producing process of this non-metal part. In the last-mentioned situation, the metal part in fact forms a carrier for the non-metal part.

It may be advantageous when the hybrid rim includes a rim base, an outer and an inner rim flange and a wheel disc having a center hole, mounting holes and/or spokes.

It may be advantageous when the composite of non-metal part and metal part forms at least the wall of the rim base of the hybrid rim.

It may be advantageous when the rim base is annularly configured, and the wall of the rim base is composed of an annular outer non-metal part and an annular inner metal part. Thereby more free space or structural space is created in radial direction. Preferably, the wall thickness of the rim base corresponds substantially to the wall thickness of known non-hybrid rims.

It may be advantageous when the rim flanges and/or the wheel disc are made of a non-metal.

It may be advantageous when the wall—made of a non-metal—of the rim base, the rim flanges and/or the wheel disc are connected to each other, preferably as one piece.

It may be advantageous when the wheel disc and/or in particular one or more than one spoke of the wheel disc is configured such that it conducts air toward rotor housing for cooling during the travelling.

It may be advantageous when the non-metal part includes a plastic, in particular a fiber composite plastic, preferably a glass fiber-reinforced plastic (glassfaserverstarkten Kunststoff, GFK) or particularly preferably a carbon fiber-reinforced plastic (carbonfaserverstarkten Kunststoff, CFK), in particular is made of such.

It may be advantageous when the plastic is connected to the metal part to form a composite bonding.

It may be advantageous when the rotor housing has a hood in the interior room of the hybrid rim between the wall of the annular rim base and the hole circle having the mounting holes.

The hood is also used for the purpose of closing the components of the wheel hub motor opposed to the environment as tightly as possible, in order to prevent the ingress of dirt or water spray from the road.

It may be advantageous when the hood of the rotor housing is arranged on the inner side of the wheel disc, which, if necessary, has the spokes.

Therefore, it is possible to devise attractive designs of the wheel disc having the spokes. Due to the fact that the hood of the rotor housing is adjacent to the wheel disc, the rotor housing can be also cooled optimally. The wheel disc and/or in particular its spokes may be so configured in their geometry and/or arrangement, that the rotor housing is successfully cooled with air during the travelling of the motor vehicle.

It may be advantageous when the hood and the annular rotor housing are configured as one piece, whereby a very good cold-transmission is ensured.

It may be advantageous when the rotor housing is configured in the manner of a rotor bell, which consists of hood and the wall—made of metal—of the annular rim base.

It may be advantageous when the rotor housing is casted or forged.

It may be advantageous when the rotor housing is produced by gravity casting, pressure casting, low-pressure casting or back pressure casting.

It may be advantageous when the rotor housing is made of light metal, in particular of an aluminum alloy.

### BRIEF DESCRIPTION OF DRAWINGS

Further details and advantageous developments of the disclosure will be acquired from the following description taken in conjunction with the drawings, in which

FIG. 1 shows a schematic perspective view of a hybrid rim according to the disclosure with a rotor bell as viewed from the outside

FIG. 2 shows a schematic perspective view of a hybrid rim according to the disclosure with a rotor bell as viewed from the inside, and

FIG. 3 shows a schematic cross-section through the hybrid rim with rotor bell according to the disclosure.

### DETAILED DESCRIPTION

If same reference numerals are used in the figures, they designate the same parts, so that in order to avoid repetitions, an already described component will not be referred to anew in every description of figures.

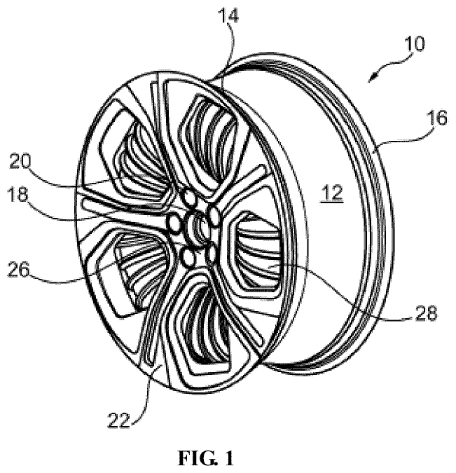

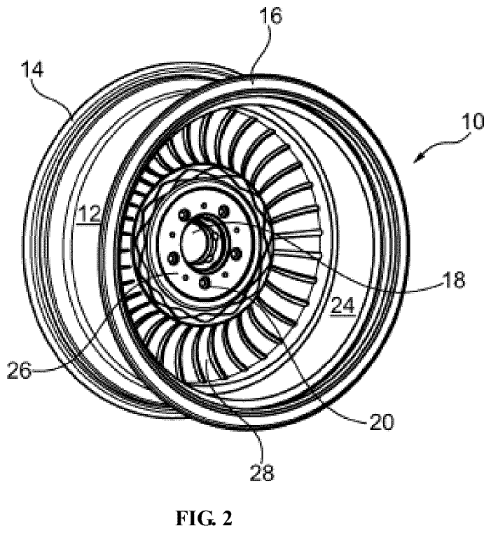

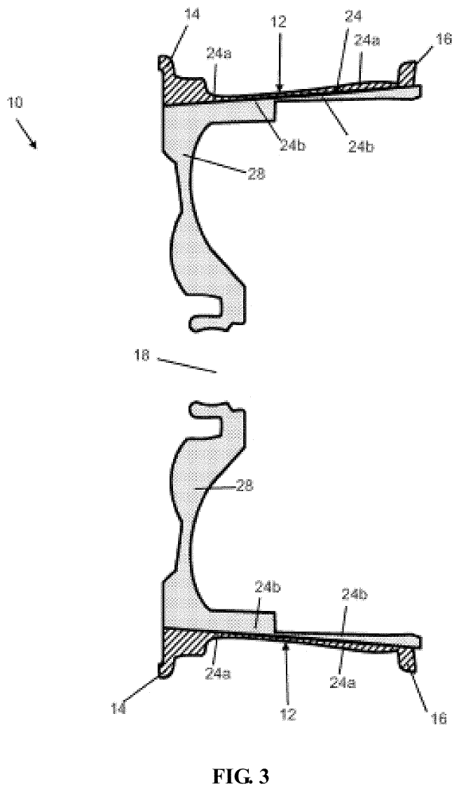

The hybrid rim 10 of a wheel provided with a wheel hub motor shown in FIGS. 1 to 3, in particular of a motor vehicle, includes a rim base 12, an outer and an inner rim flange 14, 16 and a wheel disc having a center hole 18, mounting holes 20 and spokes 22.

According to the disclosure, the hybrid rim 10 includes a non-metal part and a metal part, in which the rotor housing of the wheel hub motor at least partially forms the metal part of the hybrid rim 10.

The rim base 12 of the hybrid rim 10 is annularly configured, in which the wall 24 of the rim base 12 is composed of an annular outer non-metal part 24a and an annular inner metal part 24b, with forming a composite bonding.

The part 24a, made of a non-metal, of the rim base 12 and the rim flanges 14, 16, also made of a non-metal, are formed from one piece.

The wheel disc can also be produced from a non-metal, and either formed in one piece with at least one other non-metal part or, as a separate part, connected with at least one other non-metal part.

The non-metal part can be a carbon fiber-reinforced plastic (carbonfaserverstarkten Kunststoff, CFK).

In the present case, the rotor housing made of metal is configured in the manner of a rotor bell, which consists of hood 28 and the wall 24b—made of metal—of the annular rim base 12, in which the hood 28 of the rotor housing is formed in the interior room of the hybrid rim 10 between the wall 24 of the annular rim base 12 and the hole circle 26 having the mounting holes 20, and is arranged on the inner side to the wheel disc having spokes 22.

### LIST OF REFERENCE NUMERALS

### Is Part of the Description

10 hybrid rim
12 rim base
14 outer rim flange
16 inner rim flange
18 center hole
20 mounting hole
22 spoke
24 wall of the rim base
24a wall of the rim base made of non-metal
24b wall of the rim base made of metal
26 hole circle
28 hood

1. Hybrid rim (10) of a wheel provided with a wheel hub motor of a motor vehicle, comprising a non-metal part and a metal part, wherein a rotor housing of the wheel hub motor at least partially forms the metal part of the hybrid rim (10).

2. Hybrid rim (10) according to claim 1, wherein the non-metal part and the metal part are connected to each other in a form-, force- and/or material-fitting manner, in order to form the hybrid rim (10).

3. Hybrid rim (10) according to claim 1, wherein the hybrid rim (10) comprises a rim base (12), an outer (14) and an inner (16) rim flange (14, 16) and a wheel disc having a center hole (18), mounting holes (20) and/or spokes (22).

4. Hybrid rim (10) according to claim 3, wherein the composite of non-metal part and metal part forms at least wall (24) of the rim base (12) of the hybrid rim (10).

5. Hybrid rim (10) according to claim 4, wherein the rim base (12) is annularly configured and the wall (24) of the rim base is composed of an annular outer non-metal part (24a) and an annular inner metal part (24b).

6. Hybrid rim (10) according to claim 3, wherein the rim flanges (14, 16) and/or the wheel disc are made of a non-metal.

7. Hybrid rim (10) according to claim 3, wherein the wall (24a)—made of a non-metal—of the rim base (12), the rim flanges (14, 16) and/or the wheel disc are connected to each other.

8. Hybrid rim (10) according to claim 3, wherein the wheel disc and/or one or more than one spoke of the wheel disc is configured such that it conducts air toward the rotor housing for cooling during a driving operation.

9. Hybrid rim (10) according to claim 1, wherein the non-metal part is a plastic.

10. Hybrid rim (10) according to claim 9, wherein the plastic is connected to the metal part to form a composite bonding.

11. Hybrid rim (10) according to claim 4, wherein the rotor housing has a hood (28) in an interior room of the hybrid rim (10) between the wall (24) of the annular rim base (12) and a hole circle (26) having the mounting holes (20).

12. Hybrid rim (10) according to claim 11, wherein the hood (28) of the rotor housing is arranged on an inner side of the wheel disc, which, if necessary, has the spokes (22).

13. Hybrid rim (10) according to claim 4, wherein the rotor housing is configured in the manner of a rotor bell, which consists of hood (28) and the wall (24b)—made of metal—of the annular rim base (12).

14. Rim (10) according to claim 1, wherein the rotor housing is casted or forged.

15. Rim (10) according to claim 1, wherein the rotor housing is produced by gravity casting, pressure casting, low-pressure casting or back pressure casting.

16. Rim (10) according to claim 1, wherein the rotor housing is made of light metal.

17. Hybrid rim (10) according to claim 7, wherein the wall (24a)—made of a non-metal—of the rim base (12), the rim flanges (14, 16) and/or the wheel disc are formed as one piece.

18. Hybrid rim (10) according to claim 9, wherein the plastic is a fiber composite plastic.

19. Hybrid rim (10) according to claim 9, wherein the fiber composite plastic is a glass fiber-reinforced plastic (GFK) or a carbon fiber-reinforced plastic (CFK).

20. Rim (10) according to claim 16, wherein the light metal is an aluminum alloy.
